(19) United States
(12) Patent Application Publication
(10) Pub. No.: US 2026/0311022 A1
(43) Pub. Date: Oct. 8, 2026

(54) METHODS AND SYSTEMS FOR OPTIMIZATION OF QUANTUM CIRCUIT ENSEMBLES

(71) Applicant: QEDMA Quantum Computing LTD., Tel-Aviv (IL)

(72) Inventors: Gili Schul GANZ, Zur Hadassa (IL); Omri GOLAN, Rehovot (IL); Barak KATZIR, Haifa (IL); Yotam Yona LIFSHITZ, Shimshit (IL); Netanel Hanan LINDNER, Aviel (IL); Ittai RUBINSTEIN, Misgav (IL); Maor SHUTMAN, Tel-Aviv (IL)

(21) Appl. No.: 19/634,700

(22) Filed: Mar. 31, 2026

Related U.S. Application Data
(60) Provisional application No. 63/781,625, filed on Apr. 1, 2025.

(51) Int. Cl. G06N 10/40; G06N 10/20; G06N 10/70

(52) U.S. Cl. CPC G06N 10/40; G06N 10/20; G06N 10/70

(57) ABSTRACT

A quantum-computer control technique is disclosed for reducing quantum processing unit runtime or a number of executed measurement shots while achieving a target statistical uncertainty of an output result. Quantum circuits are sampled from a base set according to a circuit distribution, and, for each sampled circuit, a number of measurement shots is determined in accordance with a shot distribution and executed on one or more qubits to obtain measurement results. An expected variance of an expectation value estimate is computed based on the measurement results and is based on at least a shot-related variance component and a circuit-to-circuit variance component. Based on the expected variance, one or more execution parameters for a subsequent quantum computation are determined, including a number of circuits, a number of shots, and/or updated distributions, and the subsequent computation is executed accordingly. System, storage-medium, and simulation embodiments are also described.

### TECHNOLOGICAL FIELD

The present disclosure relates to the field of quantum computing, and specifically relates to techniques for improving quantum processor running time.

### BACKGROUND

Quantum computing systems execute quantum circuits on a quantum processing unit (QPU) that includes one or more qubits. In many practical uses, an output quantity of interest is derived from measurement results obtained by executing one or more quantum circuits and measuring qubit states. For example, an expectation value of an observable may be estimated from repeated measurements.

A wide range of quantum workflows involve sampling from ensembles of circuits rather than executing a single fixed circuit. In such workflows, circuits may be sampled from a distribution over circuits, and measurement results may be sampled by executing each sampled circuit multiple times (shots). In addition, some workflows involve sampling across additional dimensions such as measurement bases, observables, or initial states.

Various approaches are known for improving the quality of estimates derived from QPU measurements, including error mitigation techniques. Some error mitigation protocols use circuit ensembles constructed to emulate or compensate for noise processes, and may combine measurement results obtained from different circuit instances. Examples include protocols based on randomization (such as twirling) and protocols based on weighted combinations of results associated with different circuits. In some settings, a desired output is computed as a function of multiple expectation values, and correlations between measurement results for different terms may be considered when forming a combined estimate.

### GENERAL DESCRIPTION

There is a need in the art for techniques that improve utilization of quantum processing time when estimating output results from measurements, while retaining flexibility to operate with a range of circuit-ensemble workflows, and incorporating error mitigation.

According to some embodiments of the present disclosure, a controller operates a quantum processing unit by obtaining measurement results from executions of quantum circuits and using those measurement results to determine how further executions are to be performed. The controller may perform one or more executions of quantum circuits selected from a base set and may obtain measurement results from one or more measurement shots associated with each executed circuit. Based on at least a portion of the measurement results, the controller forms an uncertainty estimate indicative of variability expected in an estimator of an output result. The uncertainty estimate may be expressed as an expected variance associated with an expectation value estimate.

Based on the uncertainty estimate, the controller determines one or more execution parameters that govern subsequent circuit execution on the quantum processing unit. The execution parameters may include, for example, a number of quantum circuits to be sampled, a number of measurement shots per sampled circuit, a circuit distribution for sampling circuits from the base set, and/or a shot distribution for determining shot counts. The controller then operates the quantum processing unit in accordance with the determined execution parameters to obtain additional measurement results, and computes an output result based on measurement results that may include at least the additional measurement results. In this manner, quantum processing time and/or a number of executed measurement shots may be reduced for achieving a target statistical uncertainty of the output result, or statistical uncertainty may be reduced for a given quantum processing budget.

The techniques described herein are compatible with circuit-ensemble approaches used in quantum computation and may be implemented in a variety of forms. Without limiting the scope of the disclosure, the following implementations are contemplated, alone or in combination:

Uncertainty estimates reflecting circuit and shot variability. The uncertainty estimate may account for variability attributable to finite-shot measurement statistics and variability attributable to differences among sampled circuits. The expected variance may be computed using measurement results obtained by executing circuits on the quantum processing unit, including by computing one or more variance components related to measurement shots and/or one or more variance components related to circuit sampling.

Joint selection policies. Circuit sampling and shot-count determination may be performed in accordance with a joint policy defined over circuits and shot counts, including sampling from a joint distribution.

Adjustment of circuit sampling. A circuit distribution used to sample circuits from the base set may be updated based on the uncertainty estimate, and circuits for subsequent execution may be sampled according to the updated circuit distribution. In some implementations, sampling probability is biased toward circuits associated with lower estimated contribution to uncertainty relative to other circuits in the base set, and in other implementations sampling probability is biased according to a different criterion derived from the uncertainty estimate.

Adjustment of shot allocation. A shot distribution used to determine shot counts may be updated based on the uncertainty estimate, and shot counts for subsequent execution may be determined in accordance with the updated shot distribution.

Partitioned ensembles. The base set of circuits may be partitioned into subsets, circuits may be sampled separately from respective subsets according to respective distributions, and measurement results obtained for the subsets may be combined to compute the output result. Partitioning may be performed according to statistical criteria, operational criteria, or criteria associated with an error mitigation protocol.

Error mitigation integration. Subsequent execution may be performed as part of an error mitigation protocol. In some implementations, the error mitigation protocol comprises quasi-probability sampling in which measurement results associated with different circuits are combined using signs and/or weights. In implementations using quasi-probability sampling, partitioning may be performed in accordance with quasi-probability signs associated with circuits. In further implementations, the error mitigation protocol is distinct from quasi-probability sampling.

Error model and mitigation family distinctions. In some implementations, a physical error channel associated with circuit execution is treated as distinct from a depolarizing error channel. In some implementations, processing associated with an error mitigation protocol is distinct from tensor error mitigation.

Noise-channel simulation and mitigation. Circuit execution may include simulating a target noise channel by selecting and executing circuits configured to emulate the target noise channel. Measurement results may be processed to mitigate errors based on the simulated target noise channel, including implementations in which simulation and mitigation are both applied.

Measurement configurations. Circuit execution may include measurements performed according to at least two distinct measurement bases. A distribution over measurement bases may be determined and bases selected for subsequent executions in accordance with the distribution. In some implementations, different circuits in the base set correspond to different measurement bases while sharing a related state preparation.

Twirling. Circuit execution may include twirling, implemented by sampling circuits corresponding to different randomization operations and combining measurement results.

Multiple observables and target functions. The output result may be defined as a function of multiple expectation value estimates, including a linear combination or a non-linear function. Weights used to combine expectation value estimates may be determined based on covariance between measurement results or individual variance of measurement results, where the measurement results are associated with at least two observables.

Sampling of observables and initial states. The workflow may include sampling observables and/or sampling initial states. In some implementations, a joint distribution is defined over observables and circuits, and samples are drawn from the joint distribution to select circuit executions and evaluate observables.

Iterative replanning. The controller may update one or more of a circuit distribution, a shot distribution, and a base set of circuits based on measurement results, including updating iteratively over multiple stages of execution, and may execute further circuits in accordance with the updated policy.

System embodiments of the present disclosure are contemplated in which a quantum processing unit is controlled by a classical control system comprising one or more processors and one or more memories storing instructions to perform the operations described herein. Additional embodiments are contemplated in which one or more aspects are carried out using simulation of circuit execution and measurement outcomes according to a noise model.

Thus according to a broad aspect of the present disclosure, a method for operating a quantum computer comprising:
a) selecting a base set of quantum circuits executable by a quantum processing unit comprising one or more qubits;
b) sampling quantum circuits from the base set according to a circuit distribution;
c) for each sampled quantum circuit, determining a number of measurement shots in accordance with a shot distribution, executing the sampled quantum circuit on the one or more qubits for the determined number of measurement shots, and obtaining measurement results;
d) computing, based on the measurement results, an expected variance of an expectation value estimate, the expected variance being based on at least (i) a shot-related variance component and (ii) a circuit-to-circuit variance component;
e) determining, based on the expected variance, one or more execution parameters for a subsequent quantum computation, the one or more execution parameters including at least one of (i) a number of quantum circuits to be sampled, (ii) a number of measurement shots per sampled quantum circuit, (iii) an updated circuit distribution, or (iv) an updated shot distribution, and wherein the one or more execution parameters are determined to reduce quantum processing unit runtime or a number of executed measurement shots for achieving a target statistical uncertainty of the output result;
f) executing the subsequent quantum computation on the quantum processing unit in accordance with the determined execution parameters to obtain additional measurement results; and
g) processing measurement results including at least the additional measurement results to compute an output result comprising an expectation value estimate.

According to some embodiments, the method further comprises executing, on the quantum processing unit, a preliminary quantum computation comprising executing a first plurality of quantum circuits sampled from the base set and obtaining first measurement results, and wherein said computing of the expected variance is based on the first measurement results.

According to some embodiments, said computing of the expected variance comprises computing at least one of the shot-related variance component and the circuit-to-circuit variance component based on measurement results obtained by executing quantum circuits on the quantum processing unit.

According to some embodiments, said determining the one or more execution parameters comprises determining the number of quantum circuits to be sampled and the number of measurement shots per sampled quantum circuit to minimize quantum processing unit runtime while meeting the target statistical uncertainty.

According to some embodiments, sampling quantum circuits and determining the number of measurement shots are performed in accordance with a joint distribution defined over quantum circuits of the base set and shot counts.

According to some embodiments, the method further comprises updating the circuit distribution based on the computed expected variance, and sampling quantum circuits for the subsequent quantum computation according to the updated circuit distribution.

According to some embodiments, updating the circuit distribution comprises increasing a sampling probability for one or more quantum circuits associated with a lower estimated contribution to the expected variance relative to at least one other quantum circuit in the base set.

According to some embodiments, the method further comprises updating the shot distribution based on the computed expected variance, and determining the number of measurement shots for the subsequent quantum computation in accordance with the updated shot distribution.

According to some embodiments, the method further comprises partitioning the base set into a plurality of subsets, sampling quantum circuits separately from each subset according to a respective circuit distribution for the subsequent quantum computation, and combining measurement results obtained for the subsets to compute the output result.

According to some embodiments, combining measurement results comprises computing a linear combination of measurement results obtained for the subsets or partitions.

According to some embodiments, the subsequent quantum computation is performed as part of an error mitigation protocol.

According to some embodiments, the error mitigation protocol is distinct from a quasi-probability sampling protocol. According to some other embodiments, the error mitigation protocol comprises a quasi-probability sampling protocol.

According to some embodiments, processing the measurement results associated with the error mitigation protocol is distinct from processing performed in a tensor error mitigation protocol.

According to some embodiments, the subsequent quantum computation is performed as part of a quasi-probability sampling protocol, and wherein the method further comprises partitioning the base set in accordance with quasi-probability signs associated with quantum circuits of the quasi-probability sampling protocol.

According to some embodiments, executing the sampled quantum circuit comprises measuring in at least two distinct measurement bases, and wherein the method further comprises determining a distribution over measurement bases and selecting measurement bases for the subsequent quantum computation in accordance with the distribution.

According to some embodiments, the subsequent quantum computation comprises implementing twirling by sampling, from the base set, quantum circuits corresponding to different twirling operations.

According to some embodiments, the output result is a function of a plurality of expectation value estimates for a plurality of observables, and wherein the method further comprises determining weights for combining the plurality of expectation value estimates based on a covariance between measurement results associated with at least two of the observables.

According to some embodiments, the subsequent quantum computation comprises simulating a target noise channel, and wherein processing the measurement results comprises mitigating errors based on the simulated target noise channel.

According to some embodiments, the method further comprises sampling a plurality of observables and computing a plurality of expectation value estimates corresponding to the plurality of observables.

According to some embodiments, sampling the plurality of observables and sampling quantum circuits are performed in accordance with a joint distribution defined over observables and quantum circuits.

According to some embodiments, the method further comprises sampling a plurality of initial states, and executing the sampled quantum circuits comprises preparing at least one of the plurality of initial states prior to executing a sampled quantum circuit.

According to some embodiments, the method further comprises iteratively updating, based on measurement results, at least one of the circuit distribution and the shot distribution, and performing at least one further quantum computation on the quantum processing unit in accordance with the updated circuit distribution and/or the updated shot distribution to obtain further measurement results.

According to a broad aspect of the present disclosure, a method for operating a quantum processing unit comprising one or more qubits, the method comprising:
a) performing a preliminary quantum computation by sampling a first plurality of quantum circuits from a base set according to a circuit distribution, executing each sampled quantum circuit on the one or more qubits for a respective number of measurement shots, and obtaining first measurement results;
b) computing, from the first measurement results, an expected variance associated with an output result, the expected variance being based on a plurality of variance components including a shot-related variance component and a circuit-to-circuit variance component;
c) determining, based on the expected variance, a resource allocation for a second quantum computation, the resource allocation specifying at least a number of quantum circuits to be executed and a number of measurement shots to be executed for at least one of the quantum circuits;
d) performing the second quantum computation on the quantum processing unit according to the resource allocation to obtain second measurement results; and
e) processing at least the second measurement results to compute the output result.

According to some embodiments, the resource allocation is determined to reduce quantum processing unit runtime or a number of executed measurement shots while achieving a target variance or target precision of the output result.

According to a broad aspect of the present disclosure, a method for operating a quantum computer comprising a quantum processing unit, the method comprising:
a) executing, on the quantum processing unit, quantum circuits selected from a base set, wherein execution comprises performing measurement shots of the executed quantum circuits to obtain measurement results;
b) computing, from at least a subset of the measurement results, an uncertainty metric associated with an output result, the uncertainty metric being based on variance contributions attributable to (i) measurement shot statistics and (ii) variability among executed quantum circuits;
c) adaptively updating, based on the uncertainty metric, a sampling policy that governs subsequent operation of the quantum processing unit, the sampling policy defining at least one of:
a circuit selection rule or circuit distribution over the base set,
a shot allocation rule or shot distribution, or
a rule for partitioning the base set into sub-sets with respective circuit distributions;
   d) operating the quantum processing unit in accordance with the updated sampling policy to obtain additional measurement results; and
   e) computing the output result based on at least the additional measurement results.

According to a broad aspect of the present disclosure, a non-transient computer-readable storage medium storing instructions that, when executed by one or more processors of a classical control system communicatively coupled to a quantum processing unit, cause the classical control system to perform the method described herein.

According to a broad aspect of the present disclosure, a computer-implemented method comprising simulating execution of quantum circuits and measurement shots to produce simulated measurement results, and performing the method described herein using the simulated measurement results.

According to a broad aspect of the present disclosure, a system for operating a quantum computer, the system comprising:
a) a quantum processing unit comprising one or more qubits and configured to execute quantum circuits and perform measurement shots to generate measurement results; and
b) a classical control system communicatively coupled to the quantum processing unit, the classical control system comprising one or more processors and one or more memories storing instructions that, when executed by the one or more processors, cause the classical control system to:
(i) select a base set of quantum circuits executable by the quantum processing unit;
(ii) sample quantum circuits from the base set according to a circuit distribution;
(iii) for each sampled quantum circuit, determine a number of measurement shots in accordance with a shot distribution and cause the quantum processing unit to execute the sampled quantum circuit for the determined number of measurement shots to obtain measurement results;
(iv) compute, based on the measurement results, an expected variance of an expectation value estimate, the expected variance being based on at least (1) a shot-related variance component and (2) a circuit-to-circuit variance component;
(v) determine, based on the expected variance, one or more execution parameters for a subsequent quantum computation, the one or more execution parameters including at least one of (1) a number of quantum circuits to be sampled, (2) a number of measurement shots per sampled quantum circuit, (3) an updated circuit distribution, or (4) an updated shot distribution, and wherein the one or more execution parameters are determined to reduce quantum processing unit runtime or a number of executed measurement shots for achieving a target statistical uncertainty of an output result;
(vi) cause the quantum processing unit to execute the subsequent quantum computation in accordance with the determined execution parameters to obtain additional measurement results; and
(vii) process measurement results including at least the additional measurement results to compute the output result comprising an expectation value estimate.

According to some embodiments, the instructions cause the classical control system to execute, on the quantum processing unit, a preliminary quantum computation comprising executing a first plurality of quantum circuits sampled from the base set and obtaining first measurement results, and wherein the expected variance is computed based on the first measurement results.

According to some embodiments, the instructions cause the classical control system to update at least one of the circuit distribution and the shot distribution based on the computed expected variance, and to control the subsequent quantum computation in accordance with the updated circuit distribution and/or the updated shot distribution.

According to some embodiments, the subsequent quantum computation is performed as part of a quasi-probability sampling protocol, and wherein the instructions cause the classical control system to partition the base set in accordance with quasi-probability signs associated with quantum circuits of the quasi-probability sampling protocol, to sample quantum circuits separately from respective partitions, and to combine measurement results obtained for the partitions to compute the output result.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a quantum processor unit operable under control by a computer system;

FIG. 2 shows a schematic operation flow according to some embodiments of the present disclosure;

FIG. 3 exemplifies the general consideration actions according to some embodiments of the present disclosure.

### DETAILED DESCRIPTION OF EMBODIMENTS

As indicated above, the present disclosure relates to techniques for operating a quantum processing unit (QPU) with improved utilization of quantum processing time. In many implementations, a QPU is operated by executing quantum circuits for multiple measurement shots, and, in some workflows, by executing multiple circuit variants. Circuit variants may be selected, for example, to support error mitigation that compensates at least in part for errors occurring during circuit execution and measurement.

In some embodiments, the present disclosure provides a method for operating a quantum computer to process an algorithm or quantum circuit. The algorithm or circuit may be processed to define a plurality of quantum circuits, for example circuit variants and/or sub-circuits determined in view of one or more error mitigation techniques. The method includes selecting a base set of quantum circuits from the plurality of quantum circuits, defining a circuit distribution for sampling quantum circuits from the base set, and sampling quantum circuits accordingly. For each sampled quantum circuit, the method includes determining a number of measurement shots in accordance with a shot distribution, executing the sampled quantum circuit on one or more qubits (or, more generally, one or more qudits) for the determined number of measurement shots, and obtaining measurement results.

Based on the measurement results, the method includes computing an expected variance associated with an estimator of an output result, for example an expectation value estimate. The expected variance may be based on at least a shot-related variance component and a circuit-to-circuit variance component.

Based on the expected variance, the method further determines one or more execution parameters for a subsequent quantum computation. The one or more execution parameters may include at least one of: (i) a number of quantum circuits to be sampled, (ii) a number of measurement shots per sampled quantum circuit, (iii) an updated circuit distribution, and (iv) an updated shot distribution. The one or more execution parameters may be determined to reduce QPU runtime and/or reduce a number of executed measurement shots while achieving a target statistical uncertainty of the output result.

After determining the one or more execution parameters, the method includes executing the subsequent quantum computation on the QPU in accordance with the determined execution parameters to obtain additional measurement results. The measurement results are then processed, including at least the additional measurement results, to compute the output result comprising the expectation value estimate.

Accordingly, the method of the present disclosure may execute an initial set of circuit executions and, based on variance information derived from the corresponding measurement results, determine execution parameters that guide subsequent circuit execution. This enables achievement of a target statistical uncertainty with reduced quantum processing time for a given algorithm or circuit, for example by allocating circuit sampling and shot counts in a manner that improves measurement efficiency.

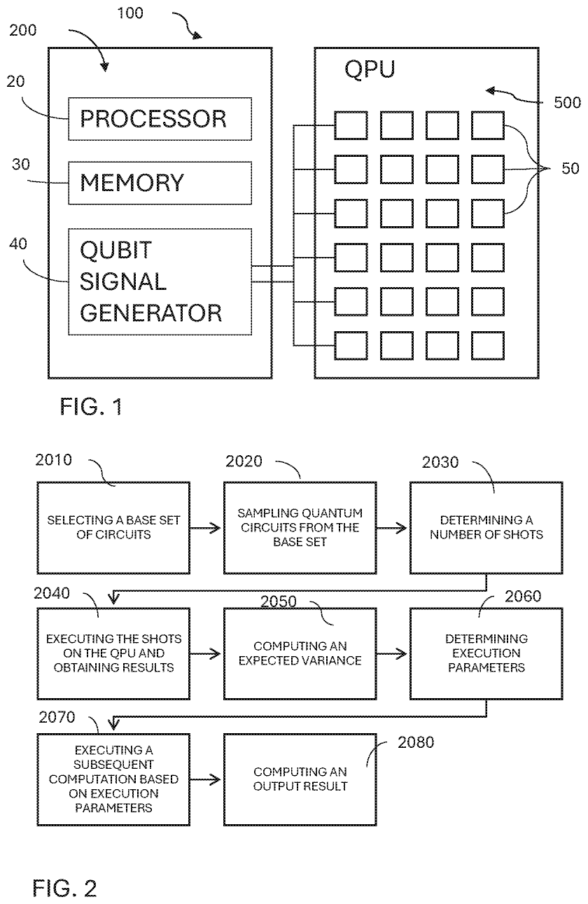

With reference to FIG. 1, a quantum processing system 100 includes a quantum processing unit (QPU) 500 comprising a plurality of qubits (or qudits) 50. The system 100 also includes a control system 200, which may be implemented by one or more classical computing devices including one or more processors 20 and one or more memory units 30. The control system 200 may further include a signal generator 40 configured to provide control signals to the qubits 50 of the QPU 500. The control system 200 may receive operational instructions, including an algorithm or circuit to be processed, via one or more input mechanisms, for example a user interface, a computer-readable medium, and/or a communication network. The control system 200 may perform the methods described herein by executing instructions stored in memory 30. The control system 200 may provide output data indicative of the output result, for example the expectation value estimate, via one or more output mechanisms, for example a user interface, a computer-readable medium, and/or a communication network.

FIG. 2 illustrates a flow diagram of an example method. After receiving an algorithm or circuit to be processed and defining circuit variants, the method includes selecting a base set of quantum circuits 2010 and sampling quantum circuits from the base set 2020. The method further includes determining a number of measurement shots 2030 and executing the sampled quantum circuits on the QPU for the determined number of measurement shots to obtain measurement results 2040. Based on the measurement results, the method includes computing an expected variance 2050 and determining execution parameters based on the expected variance 2060. The method then executes a subsequent quantum computation in accordance with the execution parameters 2070 and computes an output result 2090. The output result may be transmitted or stored in accordance with selected operational instructions.

In many quantum computing use cases, estimation of an expectation value is based on executing an ensemble of quantum circuits. For example, in certain error mitigation schemes, circuits may be selected by sampling from a quasi-probability (QP) distribution of circuits, for example in probabilistic error cancellation (PEC) and/or probabilistic error amplification (PEA). In some cases, when a target observable is not diagonal in the computational basis, it can be useful to sample from a distribution of circuits configured to measure in different measurement bases in order to estimate the observable's expectation value, including in techniques such as tensor error mitigation (TEM). In other cases, circuits may be sampled by selecting random parameters for a parameterised circuit, for example to simulate disorder. Additionally, in variational quantum algorithms (VQAs) and quantum neural network algorithms, circuits may be sampled from a distribution of parameterised circuits in order to estimate expectation values of one or more observables. Sampling may also be extended to include state-preparation operations. Further, certain error mitigation techniques use Pauli twirling, in which an original circuit is extended to an ensemble in which one or more gates are replaced by unitarily equivalent variants. In simulations, it may also be useful to sample noise trajectories for a circuit according to a noise model.

As indicated above, the technique of the present disclosure utilizes a two-step sampling enabling the operation of a quantum processor unit 500 with reduced operation time, while maintaining target statistical uncertainty of the output result. the technique can be exemplified focusing on a situation of a quantum circuit ensemble that arises from linear decomposition of a target super-operator G_{target} formed of a weighted sum of the ensemble of circuits G_{target}=ΣⱼωⱼG^{C}^{ⱼ}. Each circuit Cⱼ is a quantum circuit realizing the channel G^{C}^{ⱼ}, using the scalar weight ωⱼ. Exact implementation of the super-operator G_{target} typically requires access to all of the circuits that appear in the sum, and summing of the results according to the respective weights to obtain the expectation values of a selected observable Ô with respect to an initial state ρᵢₙᵢₜ.

$$\text{?} \text{?} \hat{O} \vert {G}_{target} \vert {ρ}_{init} \text{?} \text{?} = {\sum }_{j} {ω}_{j} \text{?} \hat{O} {\text{?}}_{{C}_{j}} .$$

As the sum may be too large to be calculated practically for all circuits, it can be estimated from a distribution of circuits, such as a sample of circuits C with probabilities pⱼ= [symbol] [C=Cⱼ], for a selected probability distribution p. Thus, for any observable Ô, the expectation value estimator can be corrected with the factor f(C)=ωⱼ/pⱼ, providing the estimator as f(C) [symbol] Ô [symbol] _{C}. and leading to [symbol] [symbol] Ô|G_{target}|ρᵢₙᵢₜ [symbol] [symbol] = [symbol] [f(C) [symbol] O [symbol] _{C}].

To simplify that, determine a circuit-to-circuit variance as [symbol] = [symbol] _{C~p}[f(C)(Ô)_{C}]. Such circuit-to-circuit variance relates to variance between circuits and does not include statistical errors incurred by running a finite number of shots. Further, a shot-to-shot variance can be quantified by [symbol] = [symbol] [f(C)² [symbol] Ô² [symbol] _{C}− [symbol] Ô² [symbol] _{C}].

Independent sampling a number N_{circ} of circuits Cᵢ from the distribution p, can be used to reduce the statistical error, providing new, unbiased, estimators for [symbol] [symbol] Ô|G_{target}|ρᵢₙᵢₜ [symbol] [symbol] , [symbol] , and [symbol] where:

$$\text{?} \text{?} \hat{O} \vert {G}_{target} \vert {ρ}_{init} \text{?} \text{?} \approx \frac{1}{{N}_{circ}} {\sum }_{i = 1}^{{N}_{circ}} f ( {C}_{i} ) \text{?} \hat{O} {\text{?}}_{{C}_{i}} ,$$

$${𝕍}_{circ} \approx \frac{1}{{N}_{circ} ( {N}_{circ} - 1 )} {\sum }_{1 \leq i < j < {N}_{circ}} {( f ( {C}_{i} ) \text{?} \hat{O} {\text{?}}_{{C}_{i}} - f ( {C}_{j} ) \text{?} \hat{O} {\text{?}}_{{C}_{j}} )}^{2} , and$$

$${𝕍}_{shot} \approx \frac{1}{{N}_{circ}} {\sum }_{i = 1}^{{N}_{circ}} {f ( {C}_{i} )}^{2} \text{?} {\hat{O}}^{2} {\text{?}}_{{C}_{i}} - {( \frac{1}{{N}_{circ}} {\sum }_{i = 1}^{{N}_{circ}} f ( {C}_{i} ) \text{?} \hat{O} {\text{?}}_{{C}_{i}} )}^{2} .$$

Additionally, the variance of the expectation value estimators has variance

$$\frac{{𝕍}_{circ}}{{N}_{circ}} = 𝕍 [ \frac{1}{{N}_{circ}} {\sum }_{i = 1}^{{N}_{circ}} f ( {C}_{i} ) \text{?} \hat{O} {\text{?}}_{{C}_{i}} ] .$$

Generally, the weights and distributions of circuits can be split into main two simplified examples. On such example relates to uniform distribution, where for a twirled circuit, the weights are ωⱼ=1/Nₜₒₜₐₗ, where Nₜₒₜₐₗ is the total number of circuits in the ensemble, where pⱼ=1/Nₜₒₜₐₗ, and f(C)=1. Alternatively, for quasi probability (QP) distributions, it may be common to take the probability distribution as pⱼ=|ωⱼ|/Σₖ|ωₖ|. This choice is motivated by Monte Carlo sampling techniques and in some cases is proven to be optimal. This choice simplifies the factors above to be equal up to a sign, providing f(Cⱼ)=sign(ωⱼ)Σₖ|ωₖ|.

The estimators for [symbol] [symbol] Ô|G_{target}|ρᵢₙᵢₜ)), [symbol] , and [symbol] , defined above can be used directly in simulations, in which quantum expectation values can be evaluated directly. However, in experimental settings, where actual quantum operations take place, statistical errors associated with shot sampling should preferably be considered.

Considering a circuit distribution p arising from the decomposition G_{target}=ΣⱼωⱼG^{C}^{ⱼ}, where after independently sampling circuits Cⱼ, the j-th circuit is sampled for Nⱼ shots, where 1<j<N_{circ}. Noting the resulting counts from the j-th circuit by

$${n}_{j}^{B}$$

for a resulting blistring B, providing Nⱼ=

$${\sum }_{B} {n}_{j}^{B} .$$

The expectation value estimator for an observable that is diagonal in the computational basis can be formulated by an estimator Oₜₒₜₐₗ in accordance with

$${O}_{total} = \frac{1}{{N}_{circ}} {\sum }_{i = 1}^{{N}_{circ}} \frac{f ( {C}_{i} )}{{N}_{i}} {\sum }_{B} {n}_{i}^{B} {o}_{B} ,$$

where o_{B} is the measurement outcome of the observable Ô on the blistering B (i.e. o_{B}|B)=Ô|B). The estimator Oₜₒₜₐₗ is an average over the independent random variable Oᵢ, and where its variance can be estimated using the estimator:

$${S}_{total}^{2} = \frac{1}{{N}_{circ} ( {N}_{circ} - 1 )} {\sum }_{i = 1}^{{N}_{circ}} {( {O}_{i} - {O}_{total} )}^{2} .$$

The resulting two estimators are unbiased providing:
[symbol] [symbol] Ô|G_{target}|ρᵢₙᵢₜ [symbol] [symbol] = [symbol] [Oₜₒₜₐₗ], and [symbol] [Oₜₒₜₐₗ]= [symbol] [S²ₜₒₜₐₗ].
   The variance estimator S²ₜₒₜₐₗ does not estimate [symbol] _{circ} or [symbol] ₛₕₒₜ directly, but relates to them by its expected value [symbol] , being the mean over repeated runs, given by

$$\text{?} [ {S}_{total}^{2} ] = \frac{1}{{N}_{circ}} ( \text{?} + \frac{1}{{N}_{shot}} {𝕍}_{shot} ) ,$$

where Nₛₕₒₜ is the harmonic mean of number of shots

$$\frac{1}{{N}_{shot}} = \frac{1}{{N}_{circ}} {\sum }_{i = 1}^{{N}_{circ}} \frac{1}{{N}_{i}} .$$

the expected value [symbol] of the variance estimator can be derived from the conditional variance relations [symbol] [Oₜₒₜₐₗ]= [symbol] [ [symbol] [Oₜₒₜₐₗ|C₁, . . . C_{N}_{_{circ}}]]+ [symbol] [ [symbol] [Oₜₒₜₐₗ|C₁, . . . N_{circ}]], together with the statistical independence of Oᵢ and the relations:

$$𝕍 [ 𝔼 [ {O}_{i} \vert {C}_{i} ] ] = 𝕍 [ f ( {C}_{i} ) {〈 \hat{O} 〉}_{{C}_{i}} ] = {𝕍}_{c i r c} ,$$

$$𝔼 [ 𝕍 [ {O}_{i} \vert {C}_{i} ] ] = 𝔼 [ {f ( {C}_{i} )}^{2} ( {〈 {\hat{O}}^{2} 〉}_{{C}_{i}} - {〈 \hat{O} 〉}_{{C}_{i}}^{2} ) / {N}_{i} ] = \frac{{𝕍}_{s h o t}}{{N}_{i}} .$$

This provides two estimators that can be sued to estimate [symbol] , and [symbol] as

$${S}_{shot}^{2} = \frac{1}{{N}_{circ}} {\sum }_{i = 1}^{{N}_{circ}} \frac{{f ( {C}_{i} )}^{2}}{{N}_{1} - 1} {\sum }_{B} {{n}_{i}^{B} ( {o}_{B} - {O}_{i} )}^{2} and {S}_{circ}^{2} = {N}_{circ} {S}_{total}^{2} - \frac{{S}_{shot}^{2}}{{N}_{shot}}$$

respectively. It is generally possible that the estimator

$${S}_{circ}^{2}$$

takes negative values. This can occur when

$${S}_{shot}^{2}$$

is overestimated or

$${S}_{circ}^{2}$$

is underestimated. In such cases, the variance estimator of the expectation-value estimator

$${S}_{total}^{2}$$

can be replaced with

$$max \{ {S}_{total}^{2} , \frac{{S}_{shot}^{2}}{{N}_{shot}} \} ,$$

which does not suffer from negative circuit-to-circuit variance estimates and corresponds to a more conservative error-bar estimation.

The following further analyses circuit-sampling-based quantum algorithms based on the above, providing an improved estimation and optimization of runtime thereof. In conventional QP-based EM schemes, variance estimation is typically recognized as a hard problem and the overhead is bounded using the QP norm W=Σⱼ|ωⱼ|. For a bound observable ∥Ô∥ₒₚ≤1, the estimators Oᵢ∈[−W, W] can be bound. Further, using Hoeffding's inequality, a bound on the required number of circuit samples can be determined to attain a precision within some probability

$${N}_{circ} \geq 2 log ( \frac{2}{δ} ) \frac{{W}^{2}}{{ϵ}^{2}} ⇒ \vert {O}_{total} - 𝔼 [ {O}_{total} ] \vert \leq ϵ$$

with probability of at least 1−δ. However, the technique of the present disclosure provides an improved bound on number of circuits by using another bound due to Hoeffding, which involves the common variance of each Oᵢ, denoted by v= [symbol] [Ôᵢ]=N_{circ} [symbol] [Oₜₒₜₐₗ]. Assuming ϵ<W+1, yields:

$${{N}_{circ} \geq {N}_{circ}^{min} = log ( \frac{2}{δ} ) \frac{W + 1}{ϵ} [ \frac{1 + ξ}{ξ} ln ( 1 + ξ ) - 1 ] ]}^{- 1}$$

Which implies that |Oₜₒₜₐₗ− [symbol] [Oₜₒₜₐₗ]|≤ϵ with probability of at least 1−δ, where ξ=(W+1)ϵ/v. Since this bound is monotonically increasing with v, the more resource consuming algorithms have large variance, providing the limit of large variance ξ<<1. At this regime, the bound is

$${N}_{circ}^{min} ≃ 2 log ( \frac{2}{δ} ) \frac{v}{{ϵ}^{2}} .$$

Assuming that the variance saturates Popoviciu's inequality v≤W², leads to the above bound for

$${N}_{circ}^{min}$$

to be the exact bound. However, for smaller variance v, an improved bound can be determined. For example, for the simple case of QP-based EM relating to global depolarizing noise channels, and for Nₛₕₒₜ≅W and traceless observables leading to v≤2W+1. For large W, this is a significant improvement over the standard bound. It should be noted that for values v=Θ(W) when W→∞, the limit considered for N_{circ} above for ξ<<1 is equivalent to ϵ<<W.

Accordingly, having a good estimate of the variance is advantageous in order to plan the resources needed to estimate an expectation value to some given (or selected) precision. However, it is not a priori clear whether estimating the variance v is an “easier” problem than estimating the expectation value [symbol] [Oₜₒₜₐₗ]. The technique of the present disclosure is based on the inventors understanding that considerably fewer samples are needed to obtain an estimate of the variance, as compared to the number of samples needed to estimate of the expectation value, given a target relative error.

Considering the variance estimator as

$${S}^{2} = {N}_{c i r c} {S}_{total}^{2} ,$$

the standard deviations of the S² and Oₜₒₜₐₗ vanish as

$$\frac{1}{\sqrt{{N}_{c i r c}}}$$

for large N_{circ}, but the decay coefficients may differ between the estimators. On the one hand, the relative error of the expectation-value estimator is

$$\frac{\sqrt{𝕍 {O}_{t o t a l}}}{\vert 𝔼 {O}_{t o t a l} \vert} \geq \sqrt{v / {N}_{c i r c}} .$$

On the other hand, the relative error of the variance estimator S² is [symbol] [S²]/ [symbol] [S²]. It is known that

$$𝕍 [ {S}^{2} ] = \frac{1}{\sqrt{{N}_{c i r c}}} ( {μ}_{4} - \frac{{N}_{circ} - 3}{{N}_{circ} - 1} {v}^{2} ) ,$$

with μ₄ being the fourth central moment of Oᵢ. Thus, the improvement in the relative error between the two estimators can be determined as

$$r = \frac{\sqrt{𝕍 [ {S}^{2} ]} / 𝔼 [ {S}^{2} ]}{\sqrt{𝕍 {O}_{t o t a l}} / \vert 𝔼 {O}_{t o t a l} \vert} \leq \sqrt{\frac{{μ}_{4}}{{v}^{3}}} \leq \sqrt{\frac{{W}^{2} + 1}{{v}^{2}} + \frac{{W}^{2}}{{v}^{3}}} .$$

where the right inequality is based on bounds determined by a theorem indicating μ₄≤

$$( {W}^{2} + \text{?} \hat{O} \text{?} ) v + ( {W}^{2} - \text{?} \hat{O} \text{?} ) \text{?} \hat{O} \text{?} \leq ( {W}^{2} + 1 ) v + {W}^{2} .$$

For the worst case variance of v=Ω(W²) as W→∞, the ratio is r=O(W⁻¹), meaning that for a fixed relative error, fewer samples are needed to estimate the variance than the number of samples needed to estimate the expectation value. Even for the more modest lower bound, of v=Ω(W) as W→∞, the ratio is r=O(W²) at worst, meaning that for a fixed relative error, a similar number of samples is needed to estimate the variance estimation and the expectation-value estimation.

In some embodiments, the technique of the present disclosure can improve the bound on μ₄ by considering one or more specific noise models, providing generic cases that lead to v=Ω(W) and μ₄=O(W²), resulting in that both the variance is easier to estimate,

$$r = O ( {W}^{- \frac{1}{2}} ) ,$$

and in condition where a fixed number of samples enables estimation of variance

$$\frac{\sqrt{𝕍 [ {S}^{2} ]}}{𝔼 [ {S}^{2} ]} = O ( {N}_{circ}^{- \frac{1}{2}} ) as W \to ∞ .$$

For example, revisiting the depolarizing noise model with traceless observable and Nₛₕₒₜ≅W provides a similar bound on μ₄. For smaller variances, the problem of estimating the expectation value to some relative error may require fewer samples, leading to that less samples are needed to estimate the expectation value directly without estimating the variance first.

The key feature for the ease of variance estimation over the expectation-value estimation is a prior knowledge that while the estimator Oᵢ lies in a large segment, the mean of the estimator in a segment an order of magnitude smaller. For this reason the variance estimation is particularly beneficial to many QP-based EM techniques such as exponential ZNE where the variance can be of order of unity and the noisy and noise-amplified expectation values are exponentially small.

Using the estimations of [symbol] and [symbol] , some embodiments of the technique of the present disclosure provide a plan for experiments with a target precision while minimizing QPU runtime. Alternatively, such an experiment can be planned with a fixed QPU runtime and minimal precision. For example, in some embodiments, the present disclosure provides for a two-step sampling quantum processing procedure utilizing some QP distribution and observable and based on the estimator Oₜₒₜₐₗ defined above for given values of [symbol] and [symbol] , and a QPU runtime function T(N_{circ}, Nₛₕₒₜ), where N_{circ} is the number of sampled circuits and Nₛₕₒₜ is the number of sampled shots in each circuit. The sample numbers N_{circ} and Nₛₕₒₜ may be selected according to the desired minimization problem.

Similarly, some embodiments of the present disclosure may relate to a processing procedure based on estimations of [symbol] and [symbol] determined by previously conducted experiments or simulations. Additionally, in cases where the QPU runtime function is not known it can be estimated or bound. For example, the QPU runtime function may be estimated in the form T(N_{circ}, Nₛₕₒₜ)=N_{circ}(t_{circ}+Nₛₕₒₜtₛₕₒₜ), where tₛₕₒₜ is the time to run a single shot and t_{circ} is the time required to enter instructions to the QPU to run a different circuit. In this case, if the time scales t_{circ} and tₛₕₒₜ are not known, they can be estimated together with [symbol] and [symbol] .

In some embodiments, obtaining an Oₜₒₜₐₗ-based estimation with a target precision ϵ and minimal QPU runtime may be based on determining a minimization problem to minimize T(N_{circ}, Nₛₕₒₜ) subject to

$${ϵ}^{2} \geq \frac{1}{{N}_{c i r c}} ( {𝕍}_{c i r c} + \frac{1}{{N}_{s h o t}} {𝕍}_{shot} ) .$$

For example, for QPU runtime function of the form T(N_{circ}, Nₛₕₒₜ)=N_{circ}(t_{circ}+Nₛₕₒₜtₛₕₒₜ), the optimization problem may utilize solving of the non-integer solution first.

In the special case of [symbol] =0 there is no reason to sample more than a single circuit, so a solution can be determined as

$${N}_{c i r c} = 1 and {N}_{shot} = ⌈ \frac{{𝕍}_{s h o t}}{{ϵ}^{2}} ⌉ .$$

In the special case that the recompilation time is negligible, being approximately t_{circ}=0. Accordingly, a solution is one-shot per circuit

$${N}_{shot} = 1 and {N}_{c i r c} = ⌈ \frac{{𝕍}_{s h o t}}{{ϵ}^{2}} ⌉ .$$

Further, considering for the non-integer solution: N_{circ}=n_{circ} and Nₛₕₒₜ=nₛₕₒₜ, and solving yields:

$${n}_{c i r c} = \frac{1}{{ϵ}^{2}} \sqrt{\frac{{𝕍}_{c i r c}}{{t}_{c i r c}}} ( \sqrt{{𝕍}_{c i r c} {t}_{c i r c}} + \sqrt{{𝕍}_{shot} {t}_{shot}} ) , {n}_{shot} = \sqrt{\frac{{𝕍}_{s h o t} {t}_{c i r c}}{{𝕍}_{c i r c} {t}_{s h o t}}} ,$$

proving

$$T ( {n}_{c irc} , {n}_{shot} ) = \frac{1}{{ϵ}^{2}} {( \sqrt{{𝕍}_{c i r c} {t}_{c i r c}} + \sqrt{{𝕍}_{shot} {t}_{shot}} )}^{2} .$$

Then reasonable integers values approximating the solution are

$${N}_{shot} = ⌈ {n}_{shot} ⌉ , and {N}_{c i r c} = ⌈ \frac{1}{{ϵ}^{2}} ( {𝕍}_{c i r c} + \frac{{𝕍}_{s h o t}}{{N}_{s h o t}} ) ⌉ .$$

Accordingly, to obtain the best precision possible with given resources of a total of t QPU runtime, the technique of the present disclosure may operate to determine the minimization problem for:

min

$$\frac{1}{{N}_{circ}} ( {𝕍}_{c i r c} + \frac{1}{{N}_{s h o t}} {𝕍}_{shot} ) ,$$

subject to t≥T(N_{circ}, Nₛₕₒₜ). While this minimization problem is similar to the above, the roles of time and precision switched. This optimization again provides an approximate solution for the simple case that the QPU runtime function is of the form T(N_{circ}, Nₛₕₒₜ)=N_{circ}(t_{circ}+Nₛₕₒₜtₛₕₒₜ). As indicated above, the solution may be identified for non-integer solutions and generalized to

$${N}_{shot} = ⌈ \frac{{𝕍}_{s h o t} {t}_{c i r c}}{{𝕍}_{c i r c} {t}_{s h o t}} ⌉ , and {N}_{c i r c} = ⌈ \frac{t}{{t}_{circ} + {N}_{shot} {t}_{shot}} ⌉ .$$

Further, such planned experiment can be modified toward a target relative precision value

$$\sqrt{𝕍 [ {O}_{total} ]} / \vert 〈 〈 \hat{O} \vert {G}_{target} \vert {ρ}_{init} 〉 〉 \vert .$$

However, planning ahead the number of circuits to be samples may require a good estimate of the expectation value. Nonetheless, if the time function is of the simple form defined above, the optimal number of shots remains

$${n}_{shot} = \sqrt{\frac{{𝕍}_{s h o t} {t}_{c i r c}}{{𝕍}_{c i r c} {t}_{s h o t}}} .$$

Accordingly, the present disclosure may utilize sampling circuits until reaching the target relative precision. Similarly, the relative-precision metric may be replaced with other metrics such as classical infidelity of the empirically obtained probability distribution with a simulated process.

Accordingly, in some embodiments, an output result of a quantum computation may be estimated by executing an ensemble of quantum circuits on a quantum processing unit. A base set of quantum circuits may be defined, e.g., as circuit variants associated with a target computation or with an error mitigation workflow. A controller samples quantum circuits from the base set according to a circuit distribution and, for each sampled circuit, determines a number of measurement shots in accordance with a shot distribution. The controller may further cause the quantum processing unit to execute the sampled circuits for the determined numbers of measurement shots to obtain measurement results, and processes the measurement results to form an expectation value estimate of an output result.

In such circuit-ensemble workflows, variability of an expectation value estimate arises from at least two sources. A first source is variability attributable to sampling different circuits from the circuit distribution (circuit-to-circuit variability). A second source is variability attributable to finite-shot measurement statistics when executing a circuit (shot-related variability). Accordingly, in some embodiments the controller computes, based on measurement results, an expected variance associated with the expectation value estimate, where the expected variance is based on at least a circuit-to-circuit variance component and a shot-related variance component. The controller may compute the expected variance using measurement results obtained during circuit execution, including computing one or more variance estimates from per-circuit measurement statistics and from variation among per-circuit estimates.

The expected variance may be used to determine execution parameters that govern subsequent circuit execution on the quantum processing unit. For example, based on the expected variance, the controller may determine a number of quantum circuits to be sampled and a number of measurement shots per sampled circuit, and/or may update at least one of the circuit distribution and the shot distribution. The execution parameters may be determined to reduce quantum processing unit runtime and/or reduce a number of executed measurement shots while achieving a target statistical uncertainty of the output result, or to reduce statistical uncertainty for a given quantum processing budget. The controller then causes a subsequent quantum computation to be executed in accordance with the determined execution parameters to obtain additional measurement results, and processes measurement results including at least the additional measurement results to compute the output result.

As indicated above, the two-step sampling structure of a quantum algorithm enables runtime optimization protocols. This can be generalized to include additional sampling steps, which may be useful in many quantum computations and in error mitigation applications.

In some embodiments, execution of a quantum computation may be modelled as an iterated sampling process having three or more nested sampling stages. For example, a controller may sample a first random variable that selects a circuit family, circuit variant, error mitigation configuration, measurement basis, observable, initial state, noise trajectory, or other execution configuration. Conditioned on the first sampled variable, the controller may sample a second variable that selects a specific quantum circuit instance from a base set and/or selects an associated measurement configuration. Conditioned on the preceding sampled variables, the controller may sample a third variable that specifies a number of measurement shots and then execute the selected circuit instance for the specified shots to obtain measurement results. More generally, the controller may define a joint or conditional sampling policy over a plurality of variables that determine how the quantum processing unit is operated.

In such multistep sampling embodiments, variability of an output result may arise from multiple variance contributions associated with different sampling stages. Accordingly, the controller may compute, based on measurement results, an expected variance associated with an estimator of the output result by evaluating variance contributions attributable to one or more of the sampling stages. The controller may then determine execution parameters for subsequent execution by allocating quantum processing resources across the sampling stages. By way of example, the controller may determine how many samples to draw at an outer sampling stage (for example, how many circuit instances, basis selections, observable selections, or other configuration samples) and how many shots to allocate for each selected configuration, such that quantum processing unit runtime and/or a number of executed measurement shots is reduced while achieving a target statistical uncertainty. The controller may further update one or more distributions or conditional distributions associated with one or more sampling stages based on computed variance information, and execute a subsequent quantum computation in accordance with the updated sampling policy.

This multistep framework may be applied in a variety of contexts. In some embodiments, an outer sampling stage selects a measurement basis or observable, and a subsequent stage selects a circuit instance configured for the selected basis or observable, followed by shot execution. In some embodiments, an outer sampling stage selects an error mitigation component, such as a subset or partition of a circuit ensemble, and subsequent stages select circuits within the selected component and allocate shots for those circuits. In some embodiments, an outer sampling stage selects a noise trajectory or other simulation configuration, and subsequent stages select circuit instances and execute shots in accordance with the selected configuration. These examples are illustrative, and the multistep sampling approach is not limited to any particular ordering or choice of sampling variables.

Generalization of the two-step optimization may be based on the estimator

$$𝔼 [ {S}_{total}^{2} ] = \frac{1}{{N}_{c i r c}} ( {𝕍}_{c i r c} + \frac{1}{{N}_{s h o t}} {𝕍}_{shot} ) ,$$

defined above, relating the number of shots and circuits sampled to the statistical error of the estimation, the following are details on the three-step sampling procedure that can be generalized to n-step sampling in a straightforward generalization.

Considering the three-stepped sampling procedure as: sample a random variable Z with a distribution [symbol] _{Z}, then sample a random variable Y conditioned on Z with a distribution [symbol] _{Y|Z}, lastly, sample a random variable X conditioned on Y and Z with a distribution [symbol] _{X|Y,Z}. The conditional-variance relation can then be extended to

$$𝕍 [ X ] = {𝕍}_{1} + {𝕍}_{2} + {𝕍}_{3} ,$$

$$where ,$$

$${𝕍}_{1} = \begin{matrix}𝕍 \\ Z ∼ {𝒟}_{Z}\end{matrix} \begin{matrix}𝔼 \\ Y ∼ {𝒟}_{Y \vert Z}\end{matrix} \begin{matrix}𝔼 \\ X ∼ {D}_{X \vert Y , Z}\end{matrix} [ X ] = 𝕍 [ 𝔼 [ 𝔼 [ X \vert Y , Z ] \vert Z ] ]$$

$${𝕍}_{2} = \begin{matrix}𝔼 \\ Z ∼ {𝒟}_{Z}\end{matrix} \begin{matrix}𝕍 \\ Y ∼ {𝒟}_{Y \vert Z}\end{matrix} \begin{matrix}𝔼 \\ X ∼ {𝒟}_{X \vert Y , Z}\end{matrix} [ X ] = 𝔼 [ 𝕍 [ 𝔼 [ X \vert Y , Z ] \vert Z ] ]$$

$${𝕍}_{3} = \begin{matrix}𝔼 \\ Z ∼ {𝒟}_{Z}\end{matrix} \begin{matrix}𝔼 \\ Y ∼ {𝒟}_{Y \vert Z}\end{matrix} \begin{matrix}𝕍 \\ X ∼ {𝒟}_{X \vert Y , Z}\end{matrix} [ X ] = 𝔼 [ 𝔼 [ 𝕍 [ X \vert Y , Z ] \vert Z ] ]$$

Now considering a process that samples N₁ times from Zᵢ~ [symbol] _{Z} for 1≤i≤N₁, for each Zᵢ sample N₂ times from Yᵢⱼ~ [symbol] _{Y|Z}_{ᵢ} for 1≤j≤N₂, lastly sample N₃ times Xᵢⱼₖ~ [symbol] _{x|Y,Z} for 1≤k≤N₃, and the random variable

$${X}_{total} = \frac{1}{{N}_{1} {N}_{2} {N}_{3}} {\sum }_{i = 1}^{{N}_{1}} {\sum }_{j = 1}^{{N}_{2}} {\sum }_{k = 1}^{N \_ 3} {X}_{i j k} ,$$

which generalizes the above described Oₜₒₜₐₗ.

This allowed to determine or compute its variance as

$$𝕍 [ {X}_{total} ] = \frac{{𝕍}_{1}}{{N}_{1}} + \frac{{𝕍}_{2}}{{N}_{1} {N}_{2}} + \frac{{𝕍}_{3}}{{N}_{1} {N}_{2} {N}_{3}} .$$

This make finding unbiased estimators for [symbol] , [symbol] , and [symbol] straightforward, and can be done as follows. Denoting

$${X}_{i} = \frac{1}{{N}_{2} {N}_{3}} {\sum }_{j = 1}^{{N}_{2}} {\sum }_{k = 1}^{{N}_{3}} {X}_{ijk} , and {X}_{i j} = \frac{1}{{N}_{3}} {\sum }_{k = 1}^{{N}_{3}} {X}_{ijk} .$$

and providing the radome variables:

$${\tilde{S}}_{1}^{2} = \frac{1}{{N}_{1} ( {N}_{1} - 1 )} {\sum }_{1 \leq i < {i}^{′} \leq {N}_{1}} {( {X}_{i} - {X}_{{i}^{′}} )}^{2} ,$$

$${\tilde{S}}_{2}^{2} = \frac{1}{{N}_{1}} {\sum }_{i = 1}^{{N}_{1}} \frac{1}{{N}_{2} ( {N}_{2} - 1 )} {\sum }_{1 \leq j < {j}^{′} \leq {N}_{2}} {( {X}_{i j} - {X}_{i {j}^{′}} )}^{2} ,$$

$${S}_{3}^{2} = \frac{1}{{N}_{1 {N}_{2}}} {\sum }_{i = 1}^{{N}_{1}} {\sum }_{j = 1}^{{N}_{2}} \frac{1}{{N}_{3} ( {N}_{3} - 1 )} {\sum }_{1 \leq k < {k}^{′} \leq {N}_{3}} {( {X}_{i j k} - {X}_{i j {k}^{′}} )}^{2} ,$$

have expectation values:

$$𝔼 [ {\tilde{S}}_{1}^{2} ] = {𝕍}_{1} + \frac{{𝕍}_{2}}{{N}_{2}} + \frac{{𝕍}_{3}}{{N}_{2} {N}_{3}} , 𝔼 [ {\tilde{S}}_{2}^{2} ] = {𝕍}_{2} + \frac{{𝕍}_{3}}{{N}_{3}} , and 𝔼 [ {S}_{3}^{2} ] = {𝕍}_{3} .$$

### Thus,

$${\tilde{S}}_{1}^{2} - {N}_{2}^{- 1} {\tilde{S}}_{2}^{2} , {\tilde{S}}_{2}^{2} - {N}_{3}^{- 1} {S}_{3}^{2} , and {S}_{3}^{2}$$

are unbiased estimators of [symbol] , [symbol] , and [symbol] , respectively. Using these estimators and the relation

$$𝕍 [ {X}_{total} ] = \frac{{𝕍}_{1}}{{N}_{1}} + \frac{{𝕍}_{2}}{{N}_{1} {N}_{2}} + \frac{{𝕍}_{3}}{{N}_{1} {N}_{2} {N}_{3}} ,$$

leads to the optimization problems

$${ϵ}^{2} \geq \frac{1}{{N}_{c i r c}} ( {𝕍}_{c i r c} + \frac{1}{{N}_{s h o t}} {𝕍}_{shot} ) and min \frac{1}{{N}_{circ}} ( {𝕍}_{c i r c} + \frac{1}{{N}_{s h o t}} {𝕍}_{shot} ) ,$$

that can be generalized to a three-step sampling problem, determining optimal N₁, N₂, and N₃.

The technique of the present disclosure may relate to different types of quantum algorithms. For example, in some algorithms the desired quantity may be a function of a few expectation values of different observables measured on different circuits. For simplicity, a case of linear combination of expectation values is described herein below, followed by a general function of expectation values. Such linear combination can be viewed as full sampling of a (typically a small) ensemble of quantum circuits and observables, such that while it is related to the circuit ensemble described above, it does not suffer from the statistical errors of sampling from the circuit ensemble. For the case of a linear combination, the description further relates to an optimization of the choice of observables. Two main prominent examples for algorithm families that include estimation of a linear combination of expectation include: Estimation of an expectation value of an observable that is not diagonal in the computational basis and Certain VQA algorithms output an estimated expectation value where the quantum circuit includes a non-unitary operation with a known decomposition as unitary gates given by the parameter shift rules. In the former cases, several circuits can be used to measure different measurements bases, and further used to reconstruct the expectation value of the target observable as a linear combination of different expectation values. If the sum is too large the measurement basis sampling can be used. In the latter case the derivative super-operator −i[ZZ, ⋅] is given as a weighted sum of super-operators

$$- i [ ZZ , \cdot ] = \hat{I} + \text{?} - 2 {\hat{R}}_{Z Z} ( \frac{π}{2} ) ,$$

where the hat signifies a super-operator and

$${\hat{R}}_{Z Z} ( θ ) = {e}^{\frac{- i θ Z Z}{2}} \cdot {e}^{\frac{i θ Z Z}{2}} .$$

Further, in another case, the EM techniques of ZNE and CDR the target expectation value is obtained via a fit to estimates of several expectation values.

Considering a case where the desired quantity is a sum of expectation values of different observables from different circuits, D=Σᵢ [symbol] Ôᵢ [symbol] , where [symbol] ₁ and Ôᵢ are the pairs of circuit and observable. In this case, an estimator for D is given by D=ΣᵢOᵢ, where Oᵢ is an estimator of the expectation value [symbol] Oᵢ [symbol] for each circuit [symbol] ᵢ. The corresponding variance of D can be expressed via the variance of each estimator Oᵢ, as [symbol] [D]=Σ [symbol] [Oᵢ], assuming that the estimators Oᵢ are independent. If the estimators are not independent, then other means of variance estimation can be used, including e.g. bootstrapping.

Considering a protocol for allocating desired precision for each expectation value estimator Oᵢ in the linear combination of expectation values in order to minimize the total QPU runtime for a fixed precision of the total sum, or in order to minimize the precision for a fixed total QPU runtime. The protocol may be formed of a first step where a variance-related quantity χᵢ is estimated for each expectation value estimator Oᵢ, and a second step where the precision Ei for is calculated for each estimator based on the xi values. The precision ϵᵢ can then be translated to the number of shots required to estimate [symbol] Ôᵢ [symbol] to this precision.

Considering the QPU runtime required to obtain an estimate of the i-th expectation value with precision ϵᵢ. This runtime as a function of precision takes the form

$${T}_{i} ( {ϵ}_{i} ) = \frac{{χ}_{i}}{{ϵ}_{i}^{2}} ,$$

where χᵢ is a constant that depends on the circuit [symbol] and properties of the QPU. For such a runtime function, the total QPU runtime can be optimized for a fixed precision ϵ of the total sum, or optimize the precision for a fixed total QPU runtime.

Generally, knowing the precisions, ϵᵢ, can be used to find the required number of samples. This is exemplified in three scenarios:

Sampling shots of each circuit [symbol] , each shot taking time t_{i,shot}, providing

$${χ}_{i} = {t}_{i , shot} ( {〈 {\hat{O}}_{i}^{2} 〉}_{{𝒞}_{i}} - {〈 {\hat{O}}_{i} 〉}_{{𝒞}_{i}}^{2} ) ,$$

and ϵᵢ can be directly translated to the required number of shots.
If the estimator Oᵢ is obtained via circuit sampling, i.e., is obtained by sampling from a distribution or QP distribution and is of the form

$${O}_{total} = \frac{1}{{N}_{c i r c}} {\sum }_{i = 1}^{{N}_{c i r c}} \frac{f ( {C}_{i} )}{{N}_{i}} {\sum }_{B} {n}_{i}^{B} {o}_{B} ,$$

a predetermined number of shots, n_{i,shot}, to sample from each circuit, provides

$${χ}_{i} = {t}_{i , c i r c} ( 𝕍 [ {〈 {\hat{O}}_{i} 〉}_{{C}_{i}} ] + {n}_{i , shot}^{- 1} E [ {〈 {\hat{O}}_{i}^{2} 〉}_{{𝒞}_{i}} - {〈 {\hat{O}}_{i} 〉}_{{𝒞}_{i}}^{2} )$$

where t_{i,circ} is the time to run n_{i,shot} shots of a sampled circuit Cᵢ, which is sampled from the distribution of circuits associated with [symbol] .

If the estimator Oᵢ is obtained via circuit sampling, i.e., by sampling from a distribution (or a QP distribution) and is of the form

$${O}_{total} = \frac{1}{{N}_{c i r c}} {\sum }_{i = 1}^{{N}_{c i r c}} \frac{f ( {C}_{i} )}{{N}_{i}} {\sum }_{B} {n}_{i}^{B} {o}_{B} ,$$

and both the number of circuits to sample and the number of shots to sample from each circuit should be selected, having estimations for the circuit-to-circuit variance [symbol] and shot-to-shot variance [symbol] . For example, in the simple case where the QPU time is of the form Tᵢ=n_{circ}(t_{i,circ}+nₛₕₒₜt_{i,shot}) with n_{circ} being the number of circuits sampled and nₛₕₒₜ is the number of shots sampled from each circuit, then the precision and runtime are related to the number of circuits and number of shots, yielding χᵢ=( [symbol] + [symbol] )².

Further, there may be main two cases describing the optimization protocols for the linear combination of expectation values, assuming that the QPU runtime is of the form.

One case relates to the problem of minimizing the total QPU runtime for a fixed precision ϵ of the total sum. This includes solving min ΣᵢTᵢ(ϵᵢ), subject to

$${ϵ}^{2} = {\sum }_{i} {ϵ}_{i}^{2} .$$

In the common use cases where QPU runtime is of the form

$${T}_{i} ( {ϵ}_{i} ) = \frac{{χ}_{i}}{{ϵ}_{i}^{2}} ,$$

the solution to is

$${ϵ}_{i} = ϵ \sqrt{\frac{\sqrt{{χ}_{i}}}{{\sum }_{j} \sqrt{{χ}_{j}}}} .$$

Another case relates to the problem of minimizing the total precision for a fixed total QPU time t. This case includes a solution for min

$${\sum }_{i} {ϵ}_{i}^{2}$$

subject to t=ΣᵢTᵢ(ϵᵢ). For the above described QPU runtime form, the solution is given by

$${ϵ}_{i}^{2} = \frac{\sqrt{{χ}_{i}}}{t} {\sum }_{j} \sqrt{{χ}_{j}} .$$

Further, in some embodiments, the target to be estimated may not be represented as a linear combination of expectation values. The technique of the present disclosure may still use the optimization protocols described above to optimize the QPU runtime. For example, this may be applied to a case where the target to be estimated is given by some function of expectation values D=f( [symbol] Ô₁ [symbol] , [symbol] Ô₂ [symbol] , with an estimator D=f(O₁, . . . Oₙ), for some estimators Oᵢ of the expectation values [symbol] Oᵢ [symbol] . Assuming the estimators are unbiased and independent, the variance of the estimator D is then given by [symbol] [D]≈Σᵢ(∂ᵢf|_{O}_{ᵢ})² [symbol] [Oᵢ], to a good approximation if the variances [symbol] [Oᵢ] are small. This approximation may rely on

$${{1 ≫ \vert f \text{((} \text{?} {\hat{O}}_{i} \text{?} )}_{i} ) + {\partial }_{j} f \vert}_{\text{?} {\hat{O}}_{i} \text{?}} \sqrt{𝕍 {O}_{i}} - f ( {( \text{?} {\hat{O}}_{i} \text{?} + {δ}_{ij} \sqrt{{𝕍O}_{j}} )}_{i} ) \vert .$$

In this case the present technique may utilize the optimization protocols described above to estimate and optimize the QPU runtime.

Assuming that the QPU runtime needed to obtain an estimator Oᵢ to precision ϵᵢ is of the form

$${T}_{i} ( {ϵ}_{i} ) = \frac{{χ}_{i}}{{ϵ}_{i}^{2}} ,$$

the total error can be written as

$${ϵ}^{2} = {\sum }_{i} {( {\partial }_{i} f )}^{2} {ϵ}_{i}^{2} .$$

Accordingly, minimizing the total QPU runtime for a fixed precision of the total sum may be adapted to the case of a non-linear functional of expectation values providing: min ΣᵢTᵢ(ϵᵢ) subject to

$${ϵ}^{2} = {\sum }_{i} {( {\partial }_{i} f )}^{2} {ϵ}_{i}^{2}$$

with the solution

$${ϵ}_{i}^{2} = \frac{{ϵ}^{2}}{{\sum }_{j} {( {\partial }_{j} f )}^{2} {ϵ}_{j}^{2}} \cdot \frac{\sqrt{{χ}_{i}}}{\vert {\partial }_{i} f \vert} .$$

Similarly, the Problem of minimizing the total precision for a fixed total QPU time to the case of a non-linear functional of expectation values may be adapted to:

$$min {\sum }_{i} {\sum }_{i} {( {\partial }_{i} f )}^{2} {ϵ}_{i}^{2} subject to t = {T}_{i} ( {ϵ}_{i} )$$

with the solution

$${ϵ}_{i}^{2} = \frac{{{Σ}_{j} ( {\partial }_{j} f )}^{2} {ϵ}_{j}^{2}}{t} \cdot \frac{\sqrt{𝒳 i}}{\vert {\partial }_{i} f \vert} .$$

In contrast to the case of linear sum of expectation values problems, the optimization for nonlinear function of expectation values problems may need estimation of the expectation values [symbol] Ôᵢ [symbol] , at which the derivatives ∂ᵢf are evaluated, in addition to the variances [symbol] [Oᵢ]. In such a case, if the estimates have small enough variance, there may be no need to run any more circuits. However, if that is not the case, the optimizations described above can be utilized but may lead to suboptimal results or results that do not satisfy the target precision. in some embodiments of the present disclosure, this may be mitigated by running the estimation in batches, where after each batch the optimization problem can be re-solved with an improved expectation-value and variance estimates. For minimizing the total QPU runtime for a fixed precision of the total sum, this means the resources allotted to each estimator Oᵢ via ϵᵢ, get updated after each batch. As for the problem of minimizing the total precision for a fixed total QPU time, after each batch the target precision is reduced according to the result of previous batches and the resources for each estimator Oᵢ are calculated via the solution to the problem.

The variance approximation and the corresponding estimation of the total error might also lead to suboptimal or unsatisfactory results, and yet a solution of these optimization problems can be used as a starting point for a more exact optimization, and still provide a reduced run time. For example, the variance [symbol] [D] can be estimated using some initial samplings for the estimators Oᵢ via bootstrapping.

For example of a non-linear combination case, the simple example of exponential ZNE EM of some observable expectation value [symbol] O [symbol] may be determined using estimations of its expectation value at the noisy circuit [symbol] Ô [symbol] and its expectation value at a noise-amplified (or reduced) circuit with amplification s>0, [symbol] Ô [symbol] , and a target precision ϵ. Typically, in exponential ZNE, a decay of the form [symbol] Ô [symbol] =e^{-s′Λ} [symbol] Ô [symbol] may be assumed for any amplification $s′>0$. The ideal value can be extrapolated as

$${〈 \hat{O} 〉}_{0} = {〈 \hat{O} 〉}_{1} {( \frac{\text{?} \hat{O} \text{?}}{\text{?} \hat{O} \text{?}} )}^{\frac{1}{s - 1}}$$

and using the total error approximation

$${ϵ}^{2} = {{Σ}_{i} ( {\partial }_{i} f )}^{2} {ϵ}_{i}^{2}$$

provides

$$\partial \text{?} \hat{O} \text{?} = {( \frac{s}{s - 1} )}^{2} {e}^{2 Λ} \partial \text{?} \hat{O} \text{?} + {( \frac{1}{s - 1} )}^{2} {e}^{2 s Λ} \partial \text{?} \hat{O} \text{?}$$

Assuming that Λ, χ₁ and χₛ (defined based on the total error) are estimated from some initial batch, the solution to minimizing the total QPU runtime for a fixed precision of the total sum can be determined by:

$$\partial \text{?} \hat{O} \text{?} = \frac{\sqrt{{𝒳}_{1}}}{\frac{s}{s - 1} {e}^{Λ}} \cdot \frac{{ϵ}^{2}}{\frac{s}{s - 1} {e}^{Λ} \sqrt{{𝒳}_{1}} + \frac{1}{s - 1} {e}^{s Λ} \sqrt{{𝒳}_{s}}} , \text{} and \partial \text{?} \hat{O} \text{?} = \frac{\sqrt{{𝒳}_{s}}}{\frac{1}{s - 1} {e}^{s Λ}} \cdot \frac{{ϵ}^{2}}{\frac{s}{s - 1} {e}^{Λ} \sqrt{{𝒳}_{1}} + \frac{1}{s - 1} {e}^{s Λ} \sqrt{{𝒳}_{s}}}$$

with the optimal total time of

$$T = \frac{1}{{ϵ}^{2}} {( \frac{s}{s - 1} {e}^{Λ} \sqrt{{𝒳}_{1}} + \frac{1}{s - 1} {e}^{s Λ} \sqrt{{𝒳}_{s}} )}^{2} .$$

Typically, an optimal amplification s may also be a common target. Using the present technique, this may relate to the functional dependence of χₛ on s. Assuming exponential dependence

$${𝒳}_{{s}^{′}} = {{𝒳}_{1} ( \frac{{𝒳}_{s}}{{𝒳}_{1}} )}^{\frac{{s}^{′} - 1}{s - 1}} ,$$

and that estimated for χ₁ and χₛ are already obtained for 0<s≠1, from a prior run, the runtime T can be minimized to find the optimal amplification s′. The minimization is straightforward and yields the optimal amplification

$${s}_{opt} = 1 + \frac{1 + 𝒲 ( {e}^{- 1} )}{A} .$$

### Where

$$A = Λ + \frac{log \sqrt{{𝒳}_{s} / {𝒳}_{1}}}{s - 1} and 𝒲$$

is principal branch of the Lambert W function, with [symbol] (e⁻¹)≈0.278, and the corresponding optimal runtime is

$${T}_{opt} = \frac{{𝒳}_{1} {e}^{2 Λ}}{{ϵ}^{2}} {( 1 + \frac{A ( 1 + {e}^{A + 𝒲 ( {e}^{- 1} )} )}{A + 𝒲 ( {e}^{- 1} )} )}^{2} .$$

It should be noted that typically, the lower bound of sₒₚₜ>0 takes precedence over this optimal amplification, so if

$$1 + \frac{1 + 𝒲 ( {e}^{- 1} )}{A} < 0$$

the amplification is determined as sₒₚₜ=0, with all resources going to estimate [symbol] Ô [symbol] directly without the exponential fitting.

Considering the scenario where the estimator is obtained through circuit sampling from a distribution, relating to sampling mitigation circuits with a fixed number of shots, an educated guesses for the ratio

$$\frac{{𝒳}_{s}}{{𝒳}_{1}}$$

appearing in the coefficient A can be made. the timescale for running [symbol] ₛ can be assumed to be independent of s. For noise amplification s>1, the variances are dominated by the noisy fixed point (for large volume circuits), then

$${𝒳}_{s} = {𝒳}_{1} and s\_opt = 1 + \frac{1 + 𝒲 ( {e}^{- 1} )}{Λ} .$$

A Considering a noise-reduced point with 0<s<1, e.g., via PEA, then the variances incur an overhead of roughly \sqrt{χₛ}∝e^{2(1-s)|F}^{ₑ}^{V}^{_{eff}} where IFₑ is the infidelity per gate and V_{eff} is the effective volume of the circuit and observable in question, This leads to

$${s}_{opt} = 1 - \frac{1 + W ( {e}^{- 1} )}{2 {IF}_{e} {V}_{eff} - Λ} .$$

Further, in many cases there is not a unique decomposition of D to a linear combination as exemplified above, even with the quantum circuits being predetermined. Accordingly, the technique of the present disclosure utilizes a freedom in choosing the circuits to run, and their corresponding observables to optimize the choice of the estimator D via minimizing its variance, sometimes even after a quantum experiment has completed its run on the QPU. In such cases, the technique is based on an assumption that the circuits and their corresponding measurements are given, thus the process may focus on the choice of the observables Ôᵢ.

For example, the processing may be directed at the expectation value of an observable that is not diagonal in the computational basis Ô=\hat{Z}₁+\hat{X}₁+\hat{Z}₂ where the indices correspond to the measured qubits, for some circuit [symbol] ₁. To estimate D= [symbol] Ô [symbol] the technique utilizes two circuits. The original [symbol] ₁ is used to estimate [symbol] \hat{Z}₁ [symbol] and [symbol] \hat{Z}₂ [symbol] , and the circuit [symbol] ₂ which is [symbol] ₁ with a Hadamard gate appended on qubit 1 to estimate [symbol] Z₁ [symbol] = [symbol] \hat{X}₁ [symbol] and [symbol] \hat{Z}₂ [symbol] = [symbol] \hat{Z}₂ [symbol] . This example can be resolved by using a single circuit in which an

$${R}_{Y} ( - \frac{π}{4} )$$

gate is added on qubit 1 before measuring in the computational basis.

Accordingly, this provides: [symbol] Ô [symbol] = [symbol] \hat{Z}₁+λ\hat{Z}₂ [symbol] + [symbol] \hat{Z}₁+(1−λ)\hat{Z}₂ [symbol] with any scalar λ. The freedom in choosing A allows selection of an optimal estimator in the sense that its variance is minimized.

While the choice of observables is continuous, as in the example hereinabove, there is usually a finite number of decompositions under consideration that span the candidate space of decompositions. Labeling each decomposition in the spanning set by some label set [symbol] , enables each labeled decomposition to be specified by its observables

$${\hat{O}}_{i}^{I}$$

so that

$$D = {\sum }_{i} {〈 {\hat{O}}_{i}^{I} 〉}_{{𝒞}_{i}}$$

for I∈ [symbol] candidate estimator D for D can be given by

$$D = {\sum }_{i} {\sum }_{I ∈ 𝒜} {λ}_{I} {O}_{i}^{I} ,$$

where [symbol] λ_{I}=1. However, since the estimators

$${O}_{i}^{I}$$

sharing the same i, i.e., being based on the same measurements, are not independent, their analysis may require consideration of the covariance between them.
In the most general case, if the covariance

$${ℂ}^{I , J} = {\sum }_{i , j} ℂov [ {O}_{i}^{I} , {O}_{j}^{J} ]$$

is given, the optimal choice of λ_{I} is given by the solution to the optimization problem min [symbol] [symbol] λ_{I}λ_{J} subject to [symbol] λ_{I}=1. The solution to this problem is given by

$${λ}_{I} = \frac{1}{{e}^{T} {ℂ}^{+} e} {( {ℂ}^{+} e )}_{I} ,$$

where [symbol] =[1 1 . . . 1] is a vector of ones of length | [symbol] | and [symbol] is the pseudo-inverse of the covariance matrix [symbol] . In case that [symbol] is not known, but only estimated, one needs to make sure that the estimation is a symmetric and non-negative matrix.

Typically, the covariance matrix may be invertible or not. If the covariance matrix is invertible, the pseudo-inverse is the inverse. If the factor [symbol] ^{T} [symbol] [symbol] is zero, then [symbol] is a zero eigenvector of [symbol] , and we can take

$${λ}_{I} = \frac{1}{\vert 𝒜 \vert}$$

to obtain a zero-variance estimator D.

For example, in a simple case where the same experiment is repeated several times, the estimated target is D= [symbol] [Oᵢ] for every i (but the different Oᵢ-s might be distributed differently) and the covariance is given by [symbol] =δ^{i,j} [symbol] [Oᵢ], where δ^{i,j}, is the Kronecker delta symbol, i.e., δ^{i,j}=1 if i=j else δ_{i,j}=0. Thus, the estimator D=ΣᵢλᵢOᵢ is the well-known inverse-variance weighted estimator

$${λ}_{i} = \frac{{𝕍 [ {O}_{i} ]}^{- 1}}{{\sum }_{j} {𝕍 [ {O}_{j} ]}^{- 1}} .$$

The inverse variance weights can also be used in more general cases of

$$D = {\sum }_{i} {\sum }_{I ∈ 𝒜} {λ}_{I} {O}_{i}^{1} ,$$

including cases where not all estimators are known with the same expectation value

$${λ}_{I} = \frac{{𝕍 ( {\sum }_{i} {O}_{i}^{I} )}^{- 1}}{{\sum }_{J ∈ 𝒜} {𝕍 ( {\sum }_{i} {O}_{i}^{J} )}^{- 1}} .$$

While the inverse-variance weights λ_{I} do not solve the optimization problem, they still yield an unbiased estimator and can be considered in cases where good estimates of the variances are known, and no good estimate of the covariance matrix [symbol] is available.

If the estimators Oᵢ are means of identically distributed random variables, such as result from repeating the same experiment up-to the number of samples

$${N}_{i} , then 𝕍 [ {O}_{i} ] ∝ \frac{1}{{N}_{i}}$$

and the coefficients

$${λ}_{i} = \frac{{N}_{i}}{{\sum }_{j} {N}_{j}} .$$

These weights can also be considered in a more general case, e.g., with respect to the candidate estimator D, where the estimators

$${O}_{i}^{I}$$

are not identically distributed but are still based on the same number of samples Nᵢ. This choice may be suitable in cases where the variances are not known and no good estimate of them is available.

In some cases, different circuits [symbol] ᵢ (of a common operation/algorithm) may differ in their final measurements, such cases may allow measurements of some complex observable Ô. More particularly, this may be based on an assumption that each circuit's final measurement consists of projections from some set of orthogonal projections, i.e., there is some set of orthogonal projections [symbol] such that the measurements in each circuit [symbol] ᵢ are from [symbol] .

For example, [symbol] may be taken to be the set of single qubit Pauli projectors

$$\frac{\hat{I} + \hat{P}}{2}$$

for each Pauli operator \hat{P}. In this case, the standard basis orthogonal measurements

$$\frac{\hat{I} + {\hat{Z}}_{j}}{2}$$

can be used, where \hat{Z}ⱼ is the Z-Pauli operator on the j-th qubit. For this [symbol] , all circuits [symbol] ᵢ can differ only by a layer of single-qubit Clifford gates before the final measurements in the standard basis.

This scenario allows the use of similar measured projectors in different circuits, i.e., E∈ [symbol] is measured in both [symbol] ᵢ and [symbol] ⱼ. Thus, an estimator for D= [symbol] Ô [symbol] is given by

$$D = {\sum }_{E ∈ ℳ} tr ( \hat{O} E ) {\sum }_{\begin{matrix}i such that \\ {𝒞}_{i} measures E\end{matrix}} {λ}_{E , i} \text{?} E \text{?}$$

where λ_{E,i} over the circuits that measure E sum to one.

The expectation value of E can be estimated in each circuit [symbol] ᵢ with an estimator E_{E,i}, providing an estimator of

$$D as D = {\sum }_{E ∈ ℳ} tr ( \hat{O} E ) {\sum }_{\begin{matrix}i such that \\ {𝒞}_{i} measures E\end{matrix}} {λ}_{E , i} {E}_{E , i} .$$

The optimization protocol described above may be applied to the choice of λ_{E,i} in this case. If the covariance matrix [symbol] ov[E_{E,i}, E_{E′,i′}] is given, the above defined λ_{I} may be applied to find the optimal choice of λ_{E,i}. On the other hand, if only [symbol] [E_{E,i}] is given the inverse-variance weighted estimator

$${λ}_{i} = \frac{{𝕍 [ {O}_{i} ]}^{- 1}}{{\sum }_{j} {𝕍 [ {O}_{j} ]}^{- 1}}$$

can be used to find a choice of λ_{E,i}. This provides good results, while may not be optimal. In case there is no given data except the number of samples run for each circuit, a suitable estimator for D can be determined using

$${λ}_{i} = \frac{{N}_{i}}{{\sum }_{j} {N}_{j}} .$$

Accordingly, in some embodiments of the present disclosure, an output result may be computed as a function of a plurality of expectation value estimates, rather than a single expectation value estimate. For example, the output result may be defined as a linear combination of expectation values associated with different observables, different measurement bases, and/or different circuit instances. In such embodiments, a controller may treat each expectation value estimate as a separate measurement task executed on a quantum processing unit and may determine execution parameters that allocate quantum processing resources across the tasks. The execution parameters may include, for each task, a number of circuit executions and/or a number of measurement shots, and the controller may select these parameters to reduce quantum processing unit runtime or a number of executed measurement shots while achieving a target statistical uncertainty of the output result.

To determine such execution parameters, the controller may compute, from measurement results obtained by executing quantum circuits on the quantum processing unit, variance information for at least a subset of the tasks, and may use the variance information to allocate precision across the tasks. In a representative implementation, a preliminary quantum computation is performed to obtain measurement results from which an expected variance (or a variance-related cost quantity) is computed for each of the expectation value estimates. The controller then determines, based on the computed variance information, per-task precision targets and corresponding shot allocations, such that the combined output result satisfies a target statistical uncertainty while total quantum runtime is reduced, or such that statistical uncertainty is reduced under a fixed quantum processing budget. This allocation may be combined with, or expressed through, updates to a circuit distribution and/or a shot distribution used to control subsequent circuit executions.

In further embodiments, the output result may be defined by a non-linear function of the plurality of expectation value estimates. In such embodiments, the controller may approximate propagation of variance through the function to relate the variance of the output result to variances of the constituent expectation value estimates, and may determine execution parameters accordingly. Additionally, where the output result admits multiple decompositions into measurable quantities, or where measurement results associated with different observables are correlated, the controller may determine weights for combining expectation value estimates based on covariance between measurement results associated with at least two observables. In this manner, the output result may be computed as a function of multiple expectation values while maintaining the variance-guided execution control described herein, including embodiments in which the controller computes weights and allocates quantum processing resources to improve measurement efficiency.

As indicated above, commonly used QP distributions for QP-based EM may be not necessarily optimal, and at times might only minimize the number of circuit and/or samples under certain conditions. This can be shown for cases where the observable has a constant expectation value over all QP-sampled circuits, and generally ignores the cost of finite shot errors. Accordingly, there may be different circuit-distributions requiring fewer samples to achieve the same accuracy. The following relates to probability distribution of circuits in [symbol] [symbol] Ô|G_{target}|ρᵢₙᵢₜ [symbol] [symbol] = [symbol] [f(C) [symbol] Ô [symbol] _{C}].

Accordingly, some embodiments of the present disclosure relate to reuse of the above-described optimization protocols to optimize the runtime of circuit-ensemble EM applications, by partitioning the circuit-distribution to sub-distributions, and optimizing each sub-distribution separately. The technique may further Apply linear-combination optimization on each partitioned sub-distribution, while sampling circuit from each sub-distribution. This is a simple application of the protocols above.

The following compares the partitioning approach for EM to the unpartitioned EM, considering a random variable s that takes different values depending on the sampled circuit, with probabilities [symbol] [s=sᵢ]=pᵢ, which is assumed to be known. The labels sᵢ partition the circuit distribution [symbol] ~QP to sub-distributions, where the partitioned sub-distribution of s=sᵢ as QPᵢ. Then, the unpartitioned EM estimator O for a single sampled circuit [symbol] has expectation [symbol] [O]= [symbol] [ [symbol] [O|s]]=Σᵢpᵢ [symbol] [O], and its variance is [symbol] [O]= [symbol] [ [symbol] [O|s]]+ [symbol] [ [symbol] [O|s]]= [symbol] [ [symbol] [O|s]]+Σᵢpᵢ [symbol] [O].

Comparing this to the case of separately sampling a circuit [symbol] ~QPᵢ with weights pᵢ from each sub-distribution, to obtain an estimator with the same mean as sampling from QP directly. In the case of Nᵢ circuits from each sub-distribution being sampled, the variance per sample is

$${𝕍}_{parts} = ( {\sum }_{i} {N}_{i} ) {\sum }_{i} {N}_{i}^{- 1} {𝕍}_{𝒞 ∼ {QP}_{i}} [ {p}_{i} {O}_{i} ]$$

By choosing the ratio between samples Nᵢ=pᵢ×Nₜₒₜₐₗ provides an improvement in the variance per sample [symbol] [O]− [symbol] = [symbol] [ [symbol] [O|s]]≥0. The main drawback to this approach relates to the need
to have enough samples of each sub-distribution to have statistically significant estimations. Thus, it is of interest to have only a few sub-distributions. The following provides examples of such partitioning as examples with a QP-based EM application, having both advantages and disadvantages.

In the usual QP-based EM, the weight associated with each circuit f( [symbol] ) as in [symbol] [symbol] Ô|G_{target}|ρᵢₙᵢₜ [symbol] [symbol] = [symbol] [f(C) [symbol] Ô [symbol] _{C}] is ±W, i.e. all weights are equal up to the sign thereof. The circuits can be partitioned into two sub-distributions, one for the circuits with positive weight and one for the circuits with negative weight.

Besides the improvement in variance described above, this partitioning is optimal under changes to the estimated observable by a constant Ô [symbol] Ô−αÎ. To understand this, consider the partitioning according to the sign of the coefficient

$$s = \frac{f ( 𝒞 )}{W} = \pm 1.$$

The total QP norm is composed of contributions from each sign W=W⁺+W⁻. Since the QP decomposition is trace preserving in leads to

$${W}^{+} - {W}^{-} = 1.$$

### Thus,

$${W}^{\pm } = \frac{W \pm 1}{2}$$

and the probabilities to sample from each sub-distribution are

$${p}_{\pm } = ℙ [ s = \pm ] = \frac{{W}^{\pm }}{W} .$$

The EM expectation-value estimator is denoted here as Wso, where the expectation value estimator o does not include the weights of the QP decomposition, and is simply an estimator of a noisy expectation value. Then, the improvement in variance is given by

$${W}^{2} 𝕍 [ s 𝔼 [ o \vert s ] ] = {W}^{2} {p}^{+} {{p}^{-} ( {𝔼}_{𝒞 ∼ {QP}_{+}} [ o ] + {𝔼}_{𝒞 ∼ {QP}_{-}} [ o ] )}^{2}$$

Under a shift of the estimator o [symbol] o−α, the terms [symbol] [o]= [symbol] [ [symbol] [o|s=±]] are invariant. In contrast, the term 0≤W² [symbol] [s [symbol] [o|s]], which is the improvement of the partitioning approach, vanishes only by choosing 2α= [symbol] [o]+ [symbol] _( [symbol] ~QP_[o]. Thus, using this partitioned sub-sampling protocol provides an estimator as good as the optimal QP-based estimator (without partitioning) out of the family of operator shifted observables.

Additionally, in most QP-based EM protocols, the QP decomposition includes the noisy circuit without any changes. In fact, for small infidelity, the coefficient of this circuit in the QP decomposition is relatively large. This motivates a partitioning to two sub-distributions of the noisy circuit and the remainder of the QP decomposition. It should be noted that considering a Pauli twirled application, the noisy circuit sub-distribution may be replaced with a Pauli twirled ensemble.

For intuition for why this two-part decomposition yields an improvement, one can consider a circuit with small infidelity IFₑ and/or volume v. Then, both variance components of

$${𝕍}_{parts} = ( {\sum }_{i} {N}_{i} ) {\sum }_{i} {N}_{i}^{- 1} {𝕍}_{𝒞 ∼ {QP}_{i}} [ {p}_{i} {O}_{i} ]$$

are small, since the noisy circuit has small variance and there is no contribution of the circuit-to-circuit variance (or small contribution for a twirled noisy circuit), and the remainder has a small variance as it constitutes a small part of the total QP norm.

A coefficient w_{noisy} of the noisy circuit, can be used to improve

$${W}^{2} 𝕍 [ 𝔼 [ O \vert s ] ] = \frac{{W}^{2} {w}_{noisy}}{W - {w}_{noisy}} {( {w}_{noisy} \text{?} \hat{O} {\text{?}}_{noisy} - \text{?} \hat{O} {\text{?}}_{ideal} )}^{2} ,$$

where w_{noisy} is the coefficient of the noisy circuit in the QP decomposition.

Taking a toy-model of a Clifford circuit with single qubit depolarization and estimating an expectation value of a Pauli observable in a Clifford with single qubit depolarization,

$$\frac{{W}^{2} 𝕍 [ 𝔼 [ O \vert s ] ]}{{𝕍}_{circ}} = \frac{{( \frac{1}{2} - f )}^{2}}{1 + f} + O ( W - 1 ) as W \to {1}^{+} ,$$

where f is the fraction of the Pauli errors in the circuit that affect the estimated Pauli observable.

In cases where the QP norm is large, the approach of partitioning the noisy reminder described above might not yield a significant improvement in the variance. To improve this a finer partition can be taken for a local QP-based EM sampling. Instead of partitioning the QP ensemble to zero-EM changes and the remainder, the ensemble can be further partitioned into k+1 sub-distributions, where the i-th sub-distribution with i≤k contains the circuits with i non-trivial local mitigation changes to the circuit, and the k+1 sub-distribution will contain the remainder.

Accordingly, in some embodiments of the present disclosure, the described method, typically directed at operating a quantum computer, may include partitioning a circuit distribution into a plurality of sub-distributions and sampling quantum circuits separately from each sub-distribution, while combining measurement results from the respective sub-distributions to compute a single output result. In this approach, the base set of quantum circuits is divided into subsets identified by a label (for example, a label determined by a property of the sampled circuit), and each subset is associated with a respective sampling distribution. The method allocates circuit samples among the sub-distributions, for example in proportions related to the respective probabilities of the labels, such that the combined estimator has the same mean as an unpartitioned estimator while reducing variance attributable to variation among the sub-distributions. This partitioning framework is particularly suitable for circuit-ensemble workflows in which a controller determines execution parameters, including numbers of circuits and shot allocations, to reduce quantum processing unit runtime or a number of executed measurement shots for achieving a target statistical uncertainty of the output result.

In further embodiments, the partitioning framework is applied to error mitigation protocols that use quasi-probability sampling. The disclosure recognizes that commonly used quasi-probability circuit distributions are not necessarily optimal under general conditions, particularly when finite-shot effects and observable-dependent effects are taken into account. Accordingly, the controller may partition a quasi-probability circuit ensemble into a small number of sub-distributions and optimize sampling and/or shot allocation for each sub-distribution separately, while combining the resulting measurement data to compute the mitigated output result. This supports embodiments in which a subsequent quantum computation is performed as part of an error mitigation protocol, including quasi-probability sampling, and in which the base set is partitioned and sampled per partition before combining results.

A representative partitioning embodiment partitions circuits by quasi-probability sign. In such embodiments, circuits associated with positive weights are placed in a first sub-distribution and circuits associated with negative weights are placed in a second sub-distribution. The controller samples circuits separately from the positive and negative sub-distributions and combines measurement results using corresponding signs and/or weights to compute the output result. This “partition-by-sign” structure can provide practical robustness, for example under shifts of the estimated observable by a constant term, and provides a concrete implementation of partitioning that is compatible with variance-guided determination of execution parameters, including updating circuit distributions, updating shot distributions, and allocating circuit samples and shots to meet a target statistical uncertainty with reduced quantum processing time.

Further in some embodiments, the quantum computation may be performed as part of a quasi-probability sampling protocol for error mitigation applied to a base set of quantum circuits implementing a Clifford computation, the technique of the present disclosure may be based on as noise model in which a single-qubit depolarizing channel can be applied after each circuit layer. This further illustrates how a controller can predict, from the structure of the circuit and the observable, how noise affects measured expectation values. Accordingly, in some embodiments measurement results obtained from executing sampled quantum circuits can be processed to compute an expected variance associated with an expectation value estimate.

This further provides closed-form expressions for variance contributions attributable to (i) variability arising from sampling different circuits under a quasi-probability distribution (a circuit-to-circuit variance component) and (ii) variability arising from finite-shot measurement statistics (a shot-related variance component). These expressions provide an engineering basis for a controller to determine execution parameters for a subsequent quantum computation, including a number of sampled circuit instances and/or a number of shots per circuit, and to do so in a manner that reduces quantum processing unit runtime or a number of executed measurement shots while achieving a target statistical uncertainty of the output result.

To this end the technique may utilize a per-qubit depolarizing channel with parameter p applied after each layer. This leads to a noisy expectation value relation, defined by [symbol] P [symbol] =(1−2p)^{f·3nL} [symbol] \hat{P} [symbol] , where f is a fraction of errors that affect the observable. This indicates an observable-dependent sensitivity.

Further, in some embodiments, the method may be used with a base set of circuits that are sampled according to a circuit distribution as part of quasi-probability-based error mitigation, where the underlying circuit execution is subject to global depolarizing noise applied after circuit layers. This defines an explicit depolarizing noise channel parameterized by A and derives relationships between ideal expectation values and noisy expectation values, including a contribution from the maximally mixed state expectation. Accordingly, in some embodiments, the controller computes, based on measurement results, an expected variance associated with an expectation value estimate in the presence of noise.

This further derives bounds on the circuit-to-circuit variance component and shot-related variance component for quasi-probability sampling under this noise model, expressed using a quasi-probability norm parameter W and quantities related to the maximally mixed state. These bounds provide examples of how a controller can determine execution parameters (such as numbers of circuit samples and shots) to achieve a target statistical uncertainty while reducing QPU runtime or executed shots. Providing higher-moment bounds (e.g., fourth moment) that can support robust uncertainty estimation and conservative planning, which is useful when the controller uses a preliminary quantum computation to estimate variance and then plans a subsequent quantum computation.

For example Global depolarizing channel can be defined by D_{λ}:ρ [symbol] 10 λρ+(1−λ)tr(ρ)I/2ⁿ, indicating that a subsequent quantum computation may comprise simulating a target noise channel, and processing the measurement results includes mitigating errors based on the simulated target noise channel.

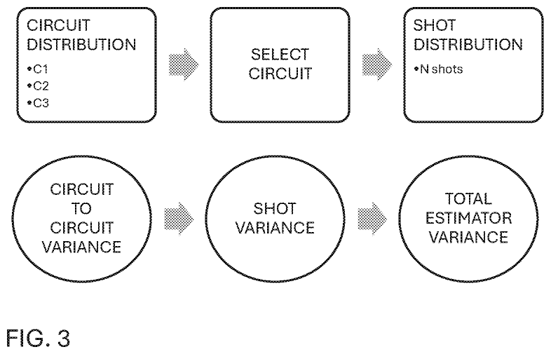

Accordingly, as indicated above, the technique of the present disclosure provides a method for operating a quantum processor unit, or for performing quantum computation using a two-step sampling structure for operating a quantum processing unit and for computing an expected variance associated with an expectation value estimate. FIG. 3 exemplified the two-step sampling structure as described herein. Generally, a controller defines a circuit distribution over a base set of quantum circuits, e.g., circuits C1, C2, C3, and samples a circuit from the base set in accordance with the circuit distribution. After a circuit is selected, the controller determines a number of measurement shots in accordance with a shot distribution, and causes the selected circuit to be executed on one or more qubits for the determined number of measurement shots to obtain measurement results.

FIG. 3 further illustrates that the uncertainty associated with an expectation value estimate may be expressed using at least two variance contributions. A first variance contribution is a circuit-to-circuit variance component V_{circ}, which reflects variability attributable to sampling different quantum circuits from the circuit distribution. A second variance contribution is a shot-related variance component Vₛₕₒₜ, which reflects variability attributable to finite-shot measurement statistics for execution of a sampled circuit. Based on measurement results obtained by executing circuits on the quantum processing unit, the controller computes an expected variance of the expectation value estimate by combining at least the circuit-to-circuit variance component and the shot-related variance component, thereby obtaining a total estimator variance (schematically shown as a total estimator variance output). This expected variance may then be used by the controller to determine one or more execution parameters for a subsequent quantum computation, including, for example, a number of circuits to be sampled, a number of shots per sampled circuit, and/or updated circuit and shot distributions.

The two-step processing technique described herein enables reducing processing time while maintaining accuracy (at least in terms of variance), enabling improvement of quantum processing efficiency.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A method for operating a quantum computer, the method comprising:
a) selecting a base set of quantum circuits executable by a quantum processing unit comprising one or more qubits;
b) sampling quantum circuits from the base set according to a circuit distribution;
c) for each sampled quantum circuit, determining a number of measurement shots in accordance with a shot distribution, executing the sampled quantum circuit on the one or more qubits for the determined number of measurement shots, and obtaining measurement results;
d) computing, based on the measurement results, an expected variance of an expectation value estimate, the expected variance being based on at least (i) a shot-related variance component and (ii) a circuit-to-circuit variance component;
e) determining, based on the expected variance, one or more execution parameters for a subsequent quantum computation, the one or more execution parameters including at least one of (i) a number of quantum circuits to be sampled, (ii) a number of measurement shots per sampled quantum circuit, (iii) an updated circuit distribution, or (iv) an updated shot distribution, and wherein the one or more execution parameters are determined to reduce quantum processing unit runtime or a number of executed measurement shots for achieving a target statistical uncertainty of the output result;
f) executing the subsequent quantum computation on the quantum processing unit in accordance with the determined execution parameters to obtain additional measurement results; and
g) processing measurement results including at least the additional measurement results to compute an output result comprising an expectation value estimate.

2. The method of claim 1, further comprising executing, on the quantum processing unit, a preliminary quantum computation comprising executing a first plurality of quantum circuits sampled from the base set and obtaining first measurement results, and wherein said computing of the expected variance is based on the first measurement results.

3. The method of claim 1, wherein said computing of the expected variance comprises computing at least one of the shot-related variance component and the circuit-to-circuit variance component based on measurement results obtained by executing quantum circuits on the quantum processing unit.

4. The method of claim 1, wherein said determining the one or more execution parameters comprises determining the number of quantum circuits to be sampled and the number of measurement shots per sampled quantum circuit to minimize quantum processing unit runtime while meeting the target statistical uncertainty.

5. The method of claim 1, further comprising updating the circuit distribution based on the computed expected variance, and sampling quantum circuits for the subsequent quantum computation according to the updated circuit distribution.

6. The method of claim 1, wherein updating the circuit distribution comprises increasing a sampling probability for one or more quantum circuits associated with a lower estimated contribution to the expected variance relative to at least one other quantum circuit in the base set.

7. The method of claim 1, further comprising updating the shot distribution based on the computed expected variance, and determining the number of measurement shots for the subsequent quantum computation in accordance with the updated shot distribution.

8. The method of claim 1, further comprising partitioning the base set into a plurality of subsets, sampling quantum circuits separately from each subset according to a respective circuit distribution for the subsequent quantum computation, and combining measurement results obtained for the subsets to compute the output result.

9. The method of claim 8, wherein combining measurement results comprises computing a linear combination of measurement results obtained for the subsets or partitions.

10. The method of claim 1, wherein the subsequent quantum computation is performed as part of an error mitigation protocol.

11. The method of claim 10, wherein the error mitigation protocol is distinct from a quasi-probability sampling protocol.

12. The method of claim 1, wherein the subsequent quantum computation is performed as part of a quasi-probability sampling protocol, and wherein the method further comprises partitioning the base set in accordance with quasi-probability signs associated with quantum circuits of the quasi-probability sampling protocol.

13. The method of claim 1, wherein executing the sampled quantum circuit comprises measuring in at least two distinct measurement bases, and wherein the method further comprises determining a distribution over measurement bases and selecting measurement bases for the subsequent quantum computation in accordance with the distribution.

14. The method of claim 1, wherein the subsequent quantum computation comprises implementing twirling by sampling, from the base set, quantum circuits corresponding to different twirling operations.

15. The method of claim 1, wherein the output result is a function of a plurality of expectation value estimates for a plurality of observables, and wherein the method further comprises determining weights for combining the plurality of expectation value estimates based on a covariance between measurement results associated with at least two of the observables.

16. A non-transient computer-readable storage medium storing instructions that, when executed by one or more processors of a classical control system communicatively coupled to a quantum processing unit, cause the classical control system to perform the method of claim 1.

17. A system for operating a quantum computer, the system comprising:
a) a quantum processing unit comprising one or more qubits and configured to execute quantum circuits and perform measurement shots to generate measurement results; and
b) a classical control system communicatively coupled to the quantum processing unit, the classical control system comprising one or more processors and one or more memories storing instructions that, when executed by the one or more processors, cause the classical control system to:
(i) select a base set of quantum circuits executable by the quantum processing unit;
(ii) sample quantum circuits from the base set according to a circuit distribution;
(iii) for each sampled quantum circuit, determine a number of measurement shots in accordance with a shot distribution and cause the quantum processing unit to execute the sampled quantum circuit for the determined number of measurement shots to obtain measurement results;
(iv) compute, based on the measurement results, an expected variance of an expectation value estimate, the expected variance being based on at least (1) a shot-related variance component and (2) a circuit-to-circuit variance component;
(v) determine, based on the expected variance, one or more execution parameters for a subsequent quantum computation, the one or more execution parameters including at least one of (1) a number of quantum circuits to be sampled, (2) a number of measurement shots per sampled quantum circuit, (3) an updated circuit distribution, or (4) an updated shot distribution, and wherein the one or more execution parameters are determined to reduce quantum processing unit runtime or a number of executed measurement shots for achieving a target statistical uncertainty of an output result;
(vi) cause the quantum processing unit to execute the subsequent quantum computation in accordance with the determined execution parameters to obtain additional measurement results; and
(vii) process measurement results including at least the additional measurement results to compute the output result comprising an expectation value estimate.

18. The system of claim 17, wherein the instructions cause the classical control system to execute, on the quantum processing unit, a preliminary quantum computation comprising executing a first plurality of quantum circuits sampled from the base set and obtaining first measurement results, and wherein the expected variance is computed based on the first measurement results.

19. The system of claim 17, wherein the instructions cause the classical control system to update at least one of the circuit distribution and the shot distribution based on the computed expected variance, and to control the subsequent quantum computation in accordance with the updated circuit distribution and/or the updated shot distribution.

20. The system of claim 17, wherein the subsequent quantum computation is performed as part of a quasi-probability sampling protocol, and wherein the instructions cause the classical control system to partition the base set in accordance with quasi-probability signs associated with quantum circuits of the quasi-probability sampling protocol, to sample quantum circuits separately from respective partitions, and to combine measurement results obtained for the partitions to compute the output result.
